(19) United States
(12) Patent Application Publication
(10) Pub. No.: US 2007/0189501 A1
(43) Pub. Date: Aug. 16, 2007

(54) Method for synchronizing contact information

(75) Inventors: Cheng-Shing Lai, Taipei (TW); Wei Zhang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp, Taipei (TW)

(21) Appl. No.: 11/653,994

(22) Filed: Jan. 17, 2007

(30) Foreign Application Priority Data
Jan. 20, 2006 (TW) 095102168

(51) Int. Cl. H04M 1/00; H04M 3/00

(52) U.S. Cl. 379/355.01

(57) ABSTRACT

A method for synchronizing the contact information, which is applied in the synchronization between a wireless exchange device and a communication device. Both the wireless exchange devices and the communication devices have a synchronization software, respectively. The synchronization software allows the wireless exchange device and the communication device to be set as a transmitter or a receiver interchangeably, and it also allows a keyword searching, multiple entries, or the entire database of contact information to be sent from the transmitter to the receiver. In addition, the synchronization software also provides a verification process to ensure the contact information is only sent to the authorized device. Therefore, the receiver can obtain the contact information stored in a contact database of the transmitter, thus achieving the aim of updating the contact databases.

### FIELD OF THE INVENTION

The invention relates to a method for synchronizing contact information, and more particularly, to a method for synchronizing contact information between a wireless exchange device and a communications device.

### BACKGROUND OF THE INVENTION

The traditional communication system generally comprises a plurality of telecommunication networks (such as PSTN—Public Switched Telephone Network) that are constructed according to various geographic areas (as in Taiwan, Britain, or Egypt) or mobile communication systems (such as GSM, PHS, or PACS). The telecommunication networks allow communication devices (such as indoor landline phones, public phones, and mobile phones) that correspond to its geographic area to connect to the network, and this enables any communication device to search and connect to the remote communication device that is also connected to the telecommunication network. As a result, users of the communication device can communicate with users of the remote communication device via the telecommunication network.

Rapid technological development allows mobile phones to match any indoor homebox and used as its wireless subordinate unit, thereby enabling users to use the mobile phone and the homebox on different occasions. However, the contact information stored in the mobile phone and the homebox are separate and cannot be exchanged freely. In other words, when the contact list of the mobile phone is modified, the contact list of the homebox remained unchanged and must be modified by users again, and vice versa, thus causing great inconvenience to users.

Therefore, it is necessary to develop a method for synchronizing the contact information of indoor homeboxes and mobile phones without raising the budget for hardware which has become an urgent issue for the industry.

### SUMMARY OF THE INVENTION

In light of the disadvantages arising from the usage of the aforesaid wireless exchange devices, a method for synchronizing contact information that can solve the problems described above is disclosed in this invention.

A main objective of the invention is to propose a method for synchronizing contact information that can be applied to a wireless exchange device and a communication device, thus allowing the contact databases included in the two devices separately to be updated at the same time. For example, the names and addresses of the contact information in the contact database can be updated simultaneously.

A further objective of the invention is to include a synchronization software into the wireless exchange device and the communication device, respectively; so that when the two devices are connected, the two synchronization software can be set at either active mode or passive mode, thereby allowing the two devices with synchronization software to serve as a transmitter or receiver. Therefore, the receiver can obtain contact information stored in the contact database of the transmitter, and achieving the aim of updating the contact database.

### BRIEF DESCRIPTION OF DRAWINGS

The foregoing aspects, as well as many of the attendant advantages and features of this invention will become more apparent by reference to the following detailed description, when taken in conjunction with the accompanying drawings, wherein:

FIG. 1 shows the connection between a wireless exchange device and a communication device according to the invention;

FIG. 2 shows the structure of the wireless exchange device according to the invention;

FIG. 3 shows the structure of the communication device according to the invention;

FIG. 4 shows the steps of the method for synchronizing contact information according to the invention;

FIG. 5 shows the process of a transmitter sending contact information according to the invention;

FIG. 6 shows the process of a receiver receiving contact information according to the invention.

### DETAILED DESCRIPTION OF PREFERRED EMBODIMENTS

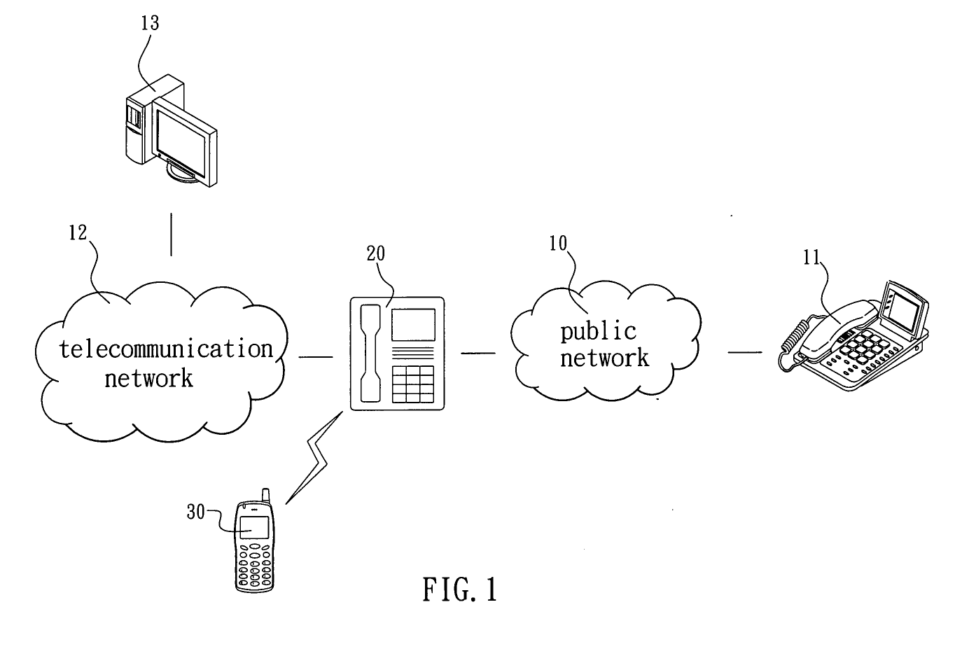

The invention discloses a method for synchronizing contact information, which is applied to the synchronization between a wireless exchange device 20 (such as wireless PABX) and a communication device 30 (such as a mobile phone), as indicated in FIG. 1. The wireless exchange device 20 can connect to a telecommunication network 10 (such as PSTN) of its geographic area (such as Egypt), and then search and connect to a remote communication device 11 (such as an indoor landline phone or mobile phone) that is also connected to the telecommunication network 10; and the wireless exchange device 20 can also connect to a public network 12 (such as the Internet), and then search and connect to a remote computer 13 that is also connected to the public network 12. Subsequently, each of the communication devices 30 can wirelessly connect to the wireless exchange device 20, and search and connect to the remote communication device 11 on the telecommunication network 10 via the wireless exchange device 20.

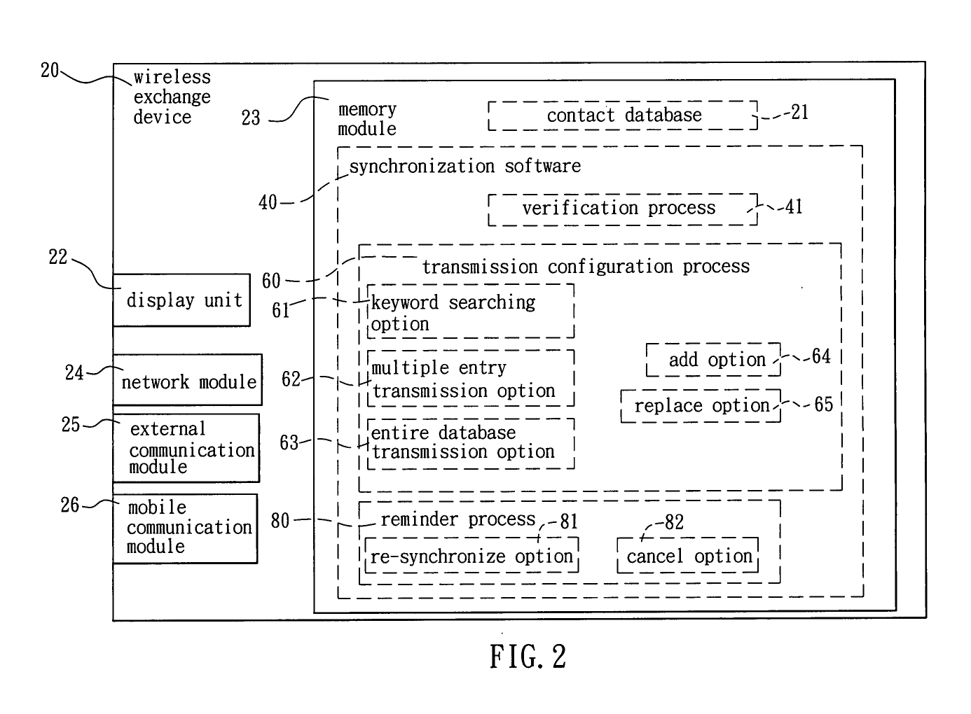

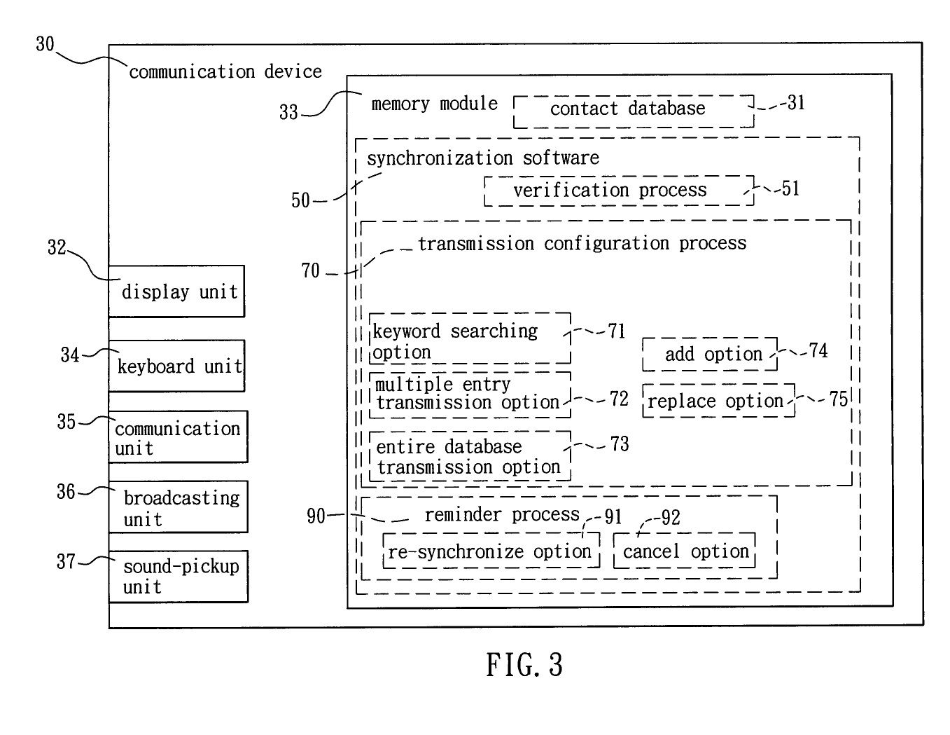

Referring to FIG. 1 and FIG. 2, the wireless exchange device 20 comprises a network module 24, an external communication module 25, and a mobile communication module 26. The network module 24 is used to connect to the public network 12, so that the wireless exchange device 20 can search and connect to the remote computer 13 from the public network 12; the external communication module 25 is used to connect to the telecommunication network 10 from the geographic area where the wireless exchange device 20 belongs; the mobile communication module 26 is used to wirelessly connect to the communication device 30. In addition, referring to FIG. 3, the communication device comprises a keyboard unit 34, a communication unit 35, a broadcasting unit 36, and a sound-pickup unit 37. The keyboard unit 34 is used to key in phone numbers or messages by users; the communication unit 35 sends and receives wireless signals, which allows the communication device 30 to connect to nearby base stations via the communication unit 35; the broadcasting unit 36 includes a speaker for broadcasting sounds; the sound-pickup unit 37 includes a microphone for receiving sounds, and the broadcasting unit 36 and the sound-pickup unit 37 allow the communication device 30 to communicate with the remote communication device 11.

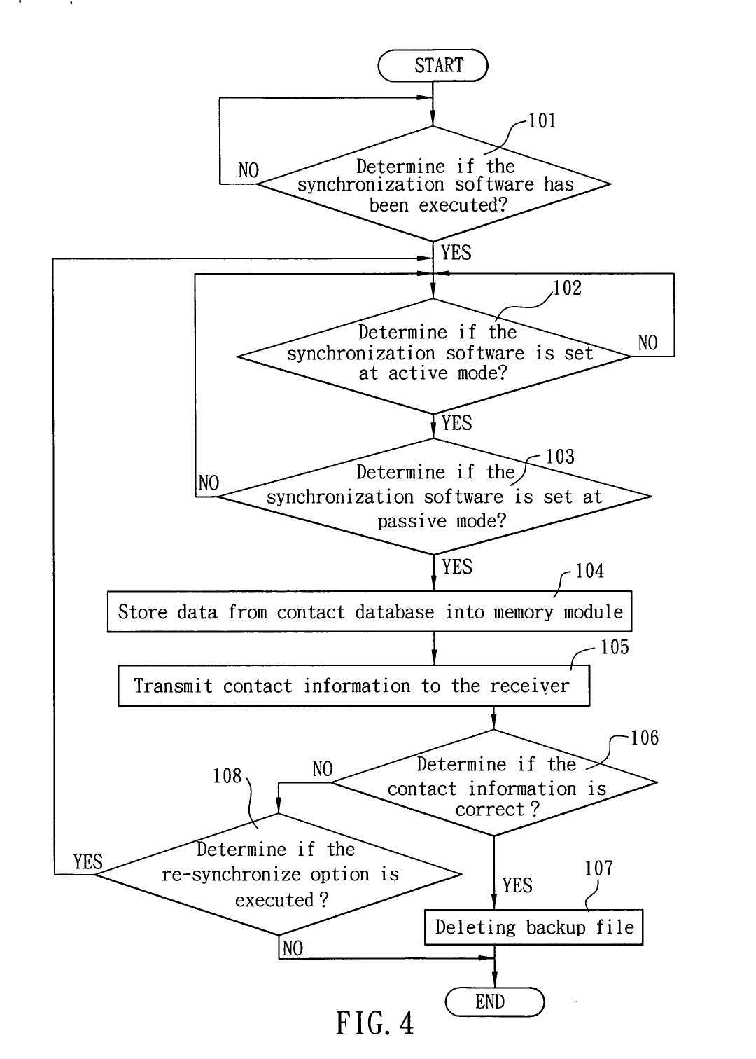

Referring to FIGS. 2 and 3, in a preferred embodiment of the invention, a contact database 21 and a contact database 31 are disposed in the wireless exchange device 20 and each of the communication devices 30, respectively, and the contact databases 21 and 31 can be used to store contact information, which includes names, phone numbers, and addresses of the contacts. Moreover, the wireless exchange device 20 includes synchronization software 40, and the communication device 30 includes synchronization software 50; the synchronization software 40 and 50 in wireless exchange device 20 and communication device 30 can be set at either active mode or passive mode by users. Consequently, when wireless exchange device 20 and communication device 30 connect to each other wirelessly, as indicated in FIG. 4; the method for synchronizing contact information can begin, comprising:

(101) Determining whether the synchronization software 40 and 50 of the wireless exchange device 20 and communication device 30 has been executed by users or not; if it has, the process moves on to step (102); if it has not, step (101) is repeated;

(102) Determining if synchronization software, either 40 or 50, has been set to active mode; if it has, the device with the synchronization software, either 40 or 50, set at active mode is used as the transmitter, and the process moves on to step (103); if it has not, step (102) is repeated;

(103) Determining if another synchronization software, either 40 or 50, has been set at passive mode; if it has, the device with the synchronization software, either 40 or 50, set at passive mode is used as the receiver, and the process moves on to step (104); if it has not, step (102) is repeated;

(104) Allowing the receiver to store (or backup) the contact information in a memory module 33 to serve as a backup file; in case the connection between devices 20 and 30 fails, the receiver can restore the backup file to the contact database 31;

(105) Allowing the receiver to generate a request according to a transmission configuration process 70 of the synchronization software 50 (such as a request for the transmission of a keyword searching, multiple entries, or all of contact information), and then sending the request to the transmitter, so that the transmitter can send the contact information recorded in its contact database 21 to the receiver according to the request;

(106) Allowing the receiver to verify the received contact information and determine if the contact information is correct; if it is, the process moves on to step (107); if it is not, it moves on to step (108) once a set period of time is up; and

(107) Allowing the receiver to store the contact information received from the transmitter in the contact database 31 according to the setting of the transmission configuration process 70, subsequently deleting the backup file from the memory module 33 and completing the synchronization process;

(108) Displaying a reminder window on a display unit 32 of the receiver according to a reminder process 90 provided in the synchronization software 50 of the receiver, and determining if a re-synchronize option 91 displayed in the reminder window is executed; if it is, step (102) is repeated; if it is not, the receiver is allowed to delete the backup file when a cancel option 92 displayed in the reminder window is executed, or when the connection between the transmitter and the receiver is interrupted, and thus ending the synchronization process.

Although the receiver is the communication device 30, and the transmitter is the wireless exchange device 20 in the aforesaid steps and in FIG. 4; it should be noted that this is only a preferred embodiment of the invention, and is not to be used to limit the invention. As long as the wireless exchange device 20 or the communication device 30 can be set as the transmitter or the receiver by setting its synchronization software 40 or 50, it should fall within the scope of the invention.

Referring to FIGS. 2, 3, and 4, each of the synchronization software 40 and 50 have a verification process 41 and 51, and verification process 41 and 51 provide a security code (or security key); the security code can be set by the users or the manufacturer by default. Therefore, when the transmitter is to wirelessly connect to the receiver and synchronize the data of the contact database 21 and 31, the verification process 51 of the receiver can send its security code to the transmitter, thereby allowing the verification process 41 of the transmitter to determine if the security code from the receiver matches its own security code. If it does, the receiver is viewed as authorized and the synchronization process begins from step (101); if it does not, the receiver is viewed as unauthorized and the connection with it is severed.

The aforesaid verification process 41 or 51 can also be executed when the synchronization software 50 or 40 of the device 30 or 20 is set as the receiver in the aforesaid step (103). Referring to FIGS. 2, 3, and 4, the verification process 51 of the receiver can also provide a verification window and display it on the display unit 32 of the receiver, so that users can key a security code into the verification window and send it to the transmitter. Subsequently, the transmitter can determine if the receiver is authorized according to the security code; if it is, the receiver is viewed as authorized and the synchronization process begins from step (101).

Referring to FIGS. 2 and 3, the transmission configuration process 60 and 70 provide an option for transmitting a keyword searching option 61 or 71, an multiple entry transmission option 62 or 72, and an option of transmitting an entire database 63 or 73 for users to execute and consequently generate a request. When any of options 71, 72, or 73 of the receiver is executed, it leads to two different responses as described below:

(1) When the keyword searching option 71 (or the multiple entry transmission option 72) is executed, the transmission configuration process 70 provides a search window for users to key in keywords (such as the names and phone numbers of the contacts), so that the transmission configuration process 70 can search the contact information that correspond to the keyword in the contact database 21 of the transmitter, and users at the receiver can select the contact information they need (can be either a keyword searching or multiple entries of contact information) from the retrieved entries of contact information; request packets that corresponding to the selected contact information are subsequently generated and sent to the transmitter, so that the transmitter can send the contact information stored in the contact database 21 to the receiver, in accordance with the contact information recorded in said request packet;

(2) When the entire database transmission option 73 is executed, the receiver generates a request packet that corresponds to option 73 and sends it to the transmitter, so that the transmitter can send all of the contact information stored in the contact database 21 to the receiver according to said request packet.

Referring to FIGS. 2 and 3, in the aforesaid transmission configuration process 60 or 70; when any of the options 61, 62, 63, 71, 72, or 73 is executed, the transmission configuration process 60 or 70 can also provide an add option 64 or 74 and a replace option 65 or 75. When the add option 74 of the receiver is executed, the receiver receives contact information from the transmitter and adds it in the order recorded in the contact database 31 of the receiver, while it also keeps the original contact information of the contact database 31 at the same time; on the other hand, when the replace option 75 of the receiver is executed, the receiver receives contact information from the transmitter and uses it to replace the contact information recorded in the contact database 31 of the receiver.

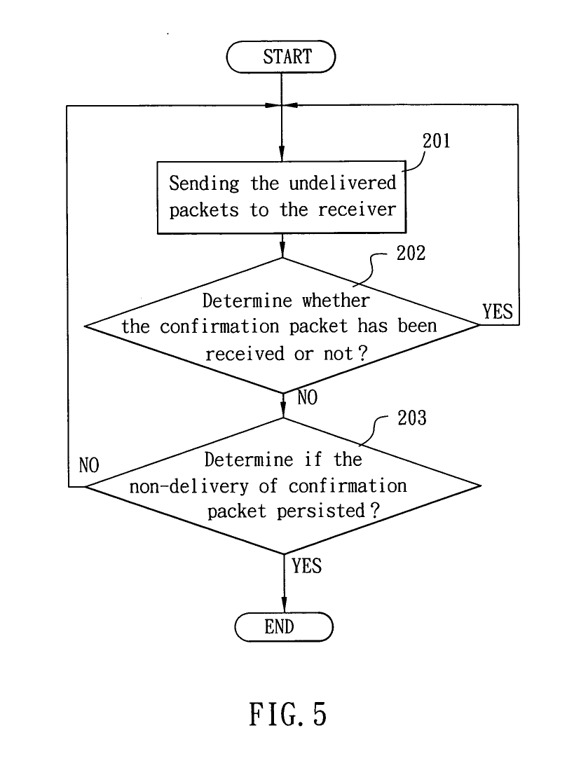

Referring to FIGS. 2, 3, and 4, in the aforesaid step (106); before the receiver receives the contact information from the transmitter, the transmitter divides the contact information into a plurality of packets and sends the packets separately to the receiver. As indicated in FIG. 5, the transmitter proceeds through steps that comprise:

(201) Sending an undelivered packet to the receiver;

(202) Determining if a confirmation packet sent from the receiver has been received within a given time; if it has, the process moves on to step (201); if it has not, the process moves on to step (203); and

(203) Determining if the confirmation packet is not received after trying a set number of times (such as 3 times); if it is, the connection to the receiver is severed, and an error message (such as connection error) is generated to instruct the users about how to deal with the problem (for example, checking the connection between the transmitter and the receiver), and the process ends here; if it is not, step (201) is repeated.

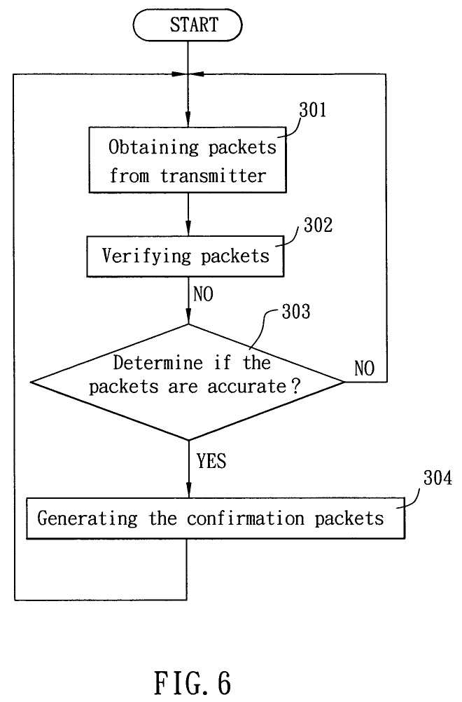

Referring to FIG. 6, the receiver proceeds through steps that comprise:

(301) Obtaining a packet from the transmitter;

(302) Verifying the accuracy of said packet; for example, using the ECC (Error Correction Code) for the purpose;

(303) Determining if the packet is accurate or not; if it is, the process moves on to step (304); if it is not, step (301) is repeated

(304) Generating a confirmation packet and sending it to the transmitter, and then the process starts over from step (301).

While the invention herein disclosed has been described by means of specific embodiments, numerous modifications and variations could be made thereto by those skilled in the art without departing from the scope and spirit of the invention set forth in the claims.

What is claimed is:

1. A method for synchronizing contact information, which is applied in the synchronization between a wireless exchange device and a communication device, the method comprising:
said wireless exchange device connecting to said communication device;
setting said wireless exchange device or said communication device as a transmitter;
when said wireless exchange device is set as a transmitter, setting said communication device as a receiver, or when said communication device is set as a transmitter, setting said wireless exchange device as a receiver;
said receiver generating a request and sending it to said transmitter;
said transmitter receiving the request, and sending contact information recorded in a contact database of said transmitter to said receiver according to the request; and
said receiver receiving said contact information, and storing said contact information in a contact database of said receiver.

2. The method of claim 1, wherein the request is generated from a setting of a transmission configuration process provided in a synchronization software of said receiver.

3. The method of claim 2, wherein the step of said receiver receiving said contact information further comprises the steps of:
determining whether said contact information is correct or not; and
when said contact information is correct, storing said contact information in said contact database of said receiver according to the setting of said transmission configuration process.

4. The method of claim 2, wherein the step of said receiver receiving said contact information further comprises the steps of:
determining whether said contact information is correct or not;
when said contact information is not correct, displaying a reminder window on a display unit of said receiver according to a reminder process provided by the synchronization software of said receiver;
after confirming a re-synchronize option is not executed, determining whether a cancel option displayed on the reminder window is executed or not; and
when said cancel option is executed, deleting said received contact information.

5. The method of claim 2, wherein when said transmitter and said receiver are connected, further comprising the steps of:
determining whether a security code of said receiver matches a security code provided in said transmitter; and
when the two security codes match with each other, accepting said receiver as authorized.

6. The method of claim 5, further comprising the steps of:
displaying a verification window on the display unit of said receiver;
inputting a security code into said verification window, and sending said security code to said transmitter for verifying said security code.

7. The method of claim 6, wherein when a keyword searching option set in the transmission configuration process of said receiver is executed, further comprising the steps of:
displaying a search window on the display unit of said receiver;
inputting a keyword into the search window;
searching the contact information that corresponds to the keyword in said transmitter;
selecting the contact information corresponding to the keyword; and
sending the selected contact information to said receiver.

8. The method of claim 6, wherein when an entire database transmission option set in the transmission configuration process of said receiver is executed, further comprises the steps of:
said receiver generating a request packet, and then sending the request packet to said transmitter; and
said transmitter sending entries of said contact information of said transmitter to said receiver.

9. The method of claim 8, wherein, when a replace option of said transmission configuration process is executed, the contact information received by said receiver from said transmitter is used to replace the contact information recorded in the contact database of said receiver.

10. The method of claim 7, wherein, when a replace option of said transmission configuration process is executed, the contact information received by said receiver from said transmitter is used to replace the contact information recorded in the contact database of said receiver.

11. The method of claim 6, wherein when a replace option of said transmission configuration process is executed, the contact information received by said receiver from said transmitter is used to replace the contact information recorded in the contact database of said receiver.

12. The method of claim 2, wherein the step of said receiver receives contact information from said transmitter further comprises the steps of:
said transmitter dividing said contact information into a plurality of packets;
said transmitter sending an undelivered packet to said receiver;
determining whether said transmitter receiving a confirmation packet sent from said receiver in a set period of time; and
if said transmitter receives the confirming packet, sending another undelivered packet to said receiver.

13. The method of claim 12, when said transmitter does not receive the confirmation packet sent from said receiver within the set period of time, further comprising the step of:
generating an error message.

14. The method of claim 12, further comprising the steps of:
said receiver obtaining the packet from said transmitter;
said receiver verifying the accuracy of the packet; and
said receiver generating the confirmation packet and sending the confirmation packet to said transmitter after determining said packet is accurate.
